(19) United States
(12) Patent Application Publication
(10) Pub. No.: US 2024/0382030 A1
(43) Pub. Date: Nov. 21, 2024

(54) SUSTAINABLE NON-STICK COOKWARE

(71) Applicant: One Hearth, Inc., Sunnyvale, CA (US)

(72) Inventors: Michael Hanuschik, Sunnyvale, CA (US); Peng Chau Quah, Kirkland, WA (US)

(21) Appl. No.: 18/663,565

(22) Filed: May 14, 2024

Related U.S. Application Data
(60) Provisional application No. 63/466,953, filed on May 16, 2023.

(51) Int. Cl. A47J 27/00; H05B 6/06

(52) U.S. Cl. CPC A47J 27/002; H05B 6/062; H05B 2213/06

(57) ABSTRACT

A sustainable non-stick cookware system that includes an inductive component that interacts with an induction coil. The system further includes a thermal distribution component that distributes heat throughout the thermal distribution component, including laterally. The system further includes a cooking surface on which a polymerized layer of seasoning is able to be formed, where: the polymerized layer of seasoning makes the cooking surface non-stick; and the polymerized layer of seasoning is able to be reformed a plurality of times on the cooking surface.

### CROSS REFERENCE TO OTHER APPLICATIONS

This application claims priority to U.S. Provisional Patent Application No. 63/466,953 entitled SUSTAINABLE NON-STICK COOKWARE filed May 16, 2023 which is incorporated herein by reference for all purposes.

### BACKGROUND OF THE INVENTION

Non-stick cookware is desirable for its ability to cook food (e.g., eggs) that would otherwise stick to other types of cookware without cooking oil or fat, making non-stick cookware desirable for people trying to manage their intake of oil and fat. A common way to manufacture non-stick cookware is to apply a synthetic compound with non-stick properties (e.g., polytetrafluoroethylene (PTFE), per-and polyfluoroalkyl substances (PFAS), etc.) to the cooking surface.

There is increasing concern about the long-term health effects of using non-stick cookware manufactured with synthetic compounds such as PTFE or PFAS. These synthetic non-stick coatings also tend to scratch off with use and the cookware eventually needs to be replaced, sometimes only after a year or two. New types of non-stick cookware that are more sustainable (e.g., because they do not need to be replaced as frequently), with fewer health concerns, and offer better cooking performance (e.g., even when used with less expensive and/or less sophisticated induction cooktops) would be desirable.

### BRIEF DESCRIPTION OF THE DRA WINGS

Various embodiments of the invention are disclosed in the following detailed description and the accompanying drawings.

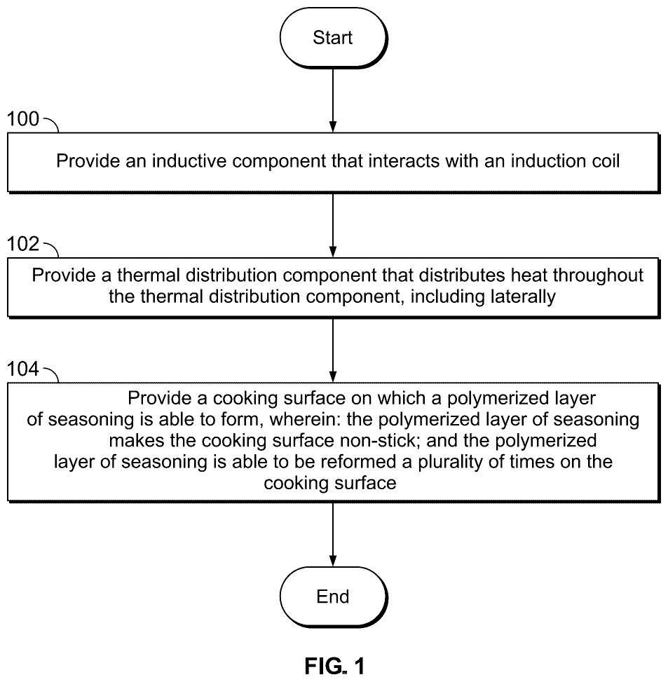

FIG. 1 is a flowchart illustrating an embodiment of a process to provide sustainable non-stick cookware.

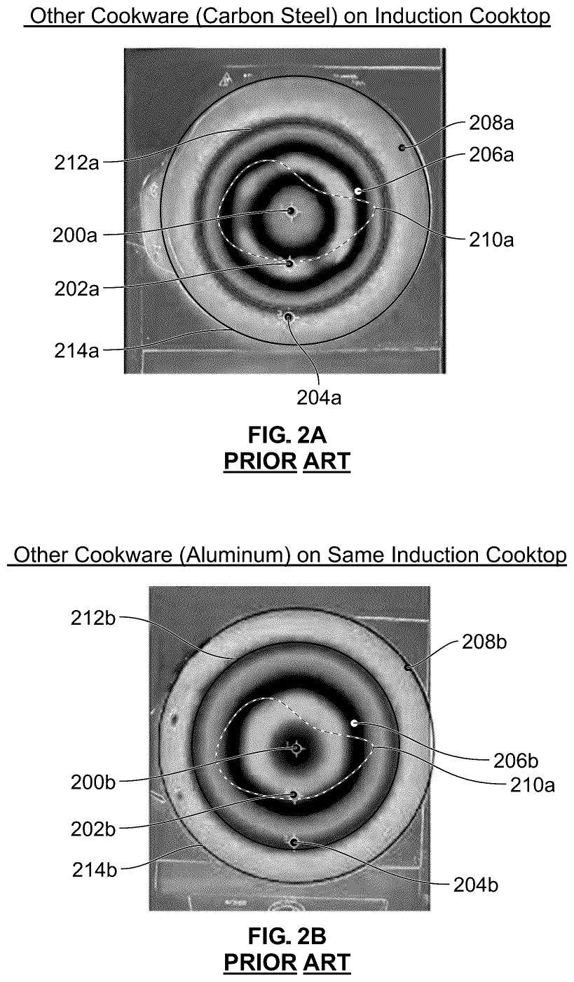

FIG. 2A is a thermal image illustrating a first example of another type of cookware on an induction cooktop.

FIG. 2B is a thermal image illustrating a second example of another type of cookware on an induction cooktop.

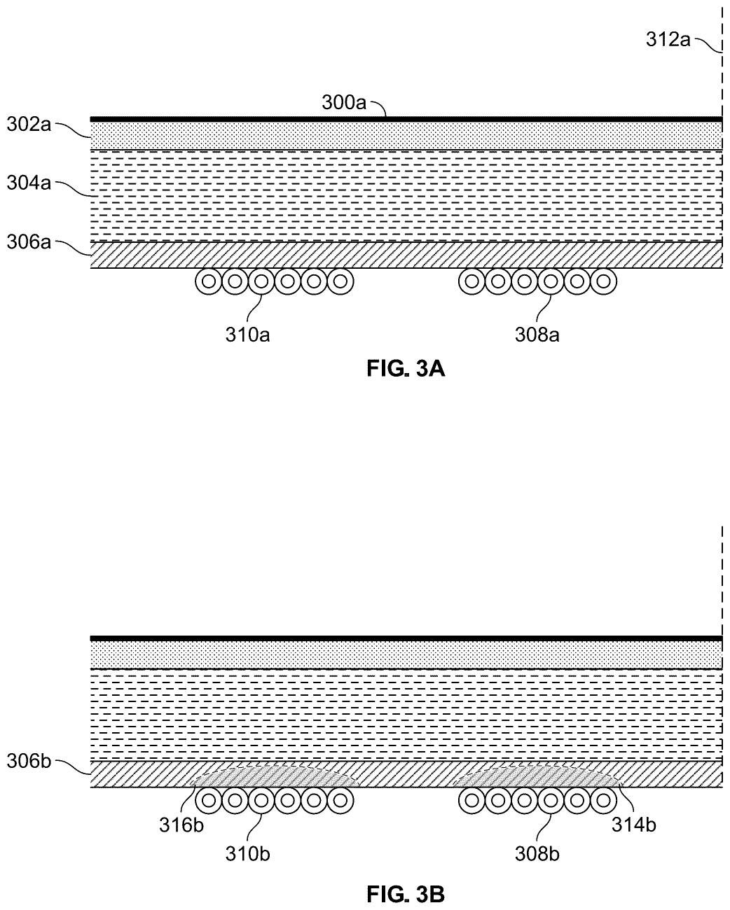

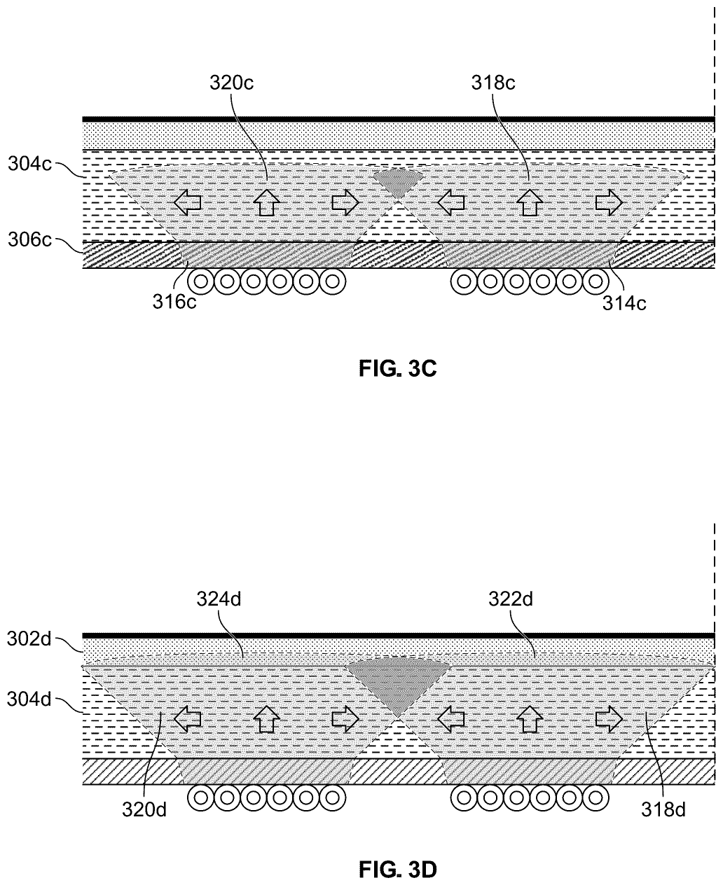

FIG. 3A is a cross-sectional diagram illustrating an embodiment of sustainable non-stick cookware, with an overlay clad configuration, before induction coils are turned on.

FIG. 3B is a cross-sectional diagram illustrating an embodiment of sustainable non-stick cookware, with an overlay clad configuration, after the induction coils are turned on.

FIG. 3C is a cross-sectional diagram illustrating an embodiment of sustainable non-stick cookware, with an overlay clad configuration, with the thermal distribution component distributing heat laterally in addition to vertically.

FIG. 3D is a cross-sectional diagram illustrating an embodiment of sustainable non-stick cookware, with an overlay clad configuration, with the cooking surface heating up.

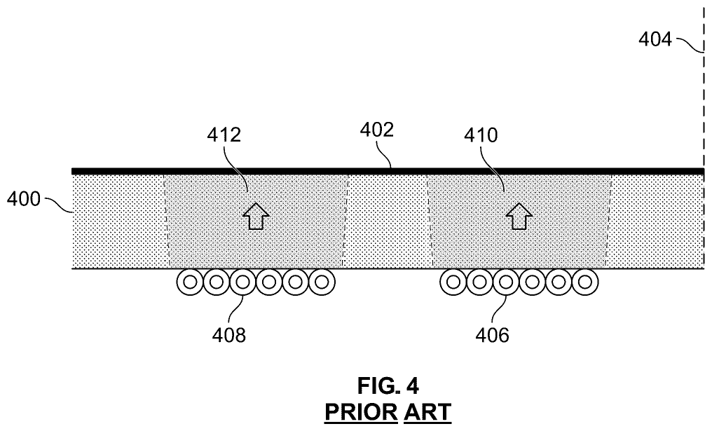

FIG. 4 is a cross-sectional diagram illustrating an example of another type of cookware.

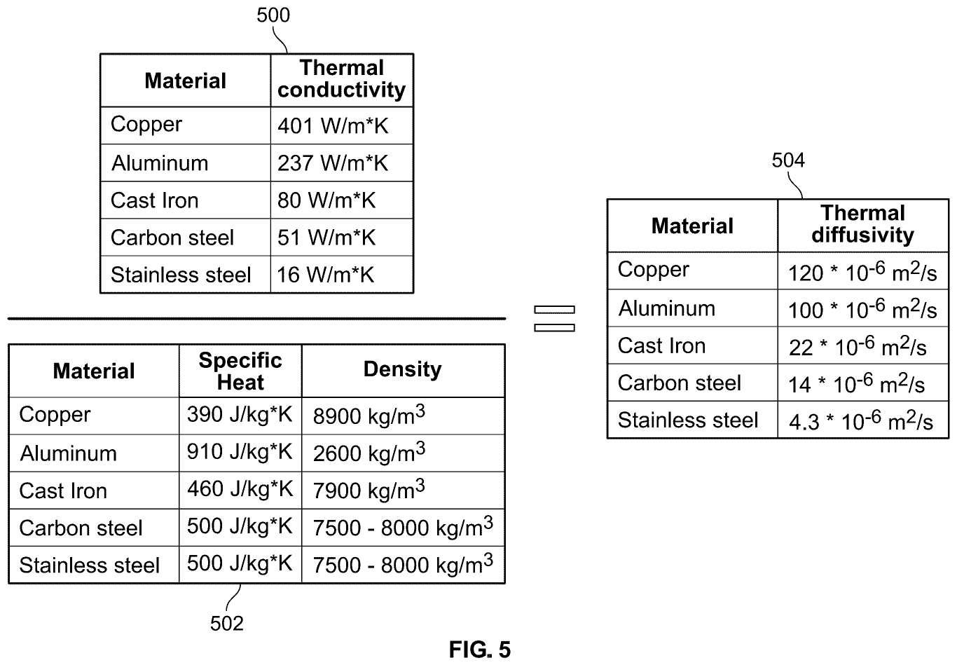

FIG. 5 is a diagram illustrating an embodiment of thermal values associated with various materials.

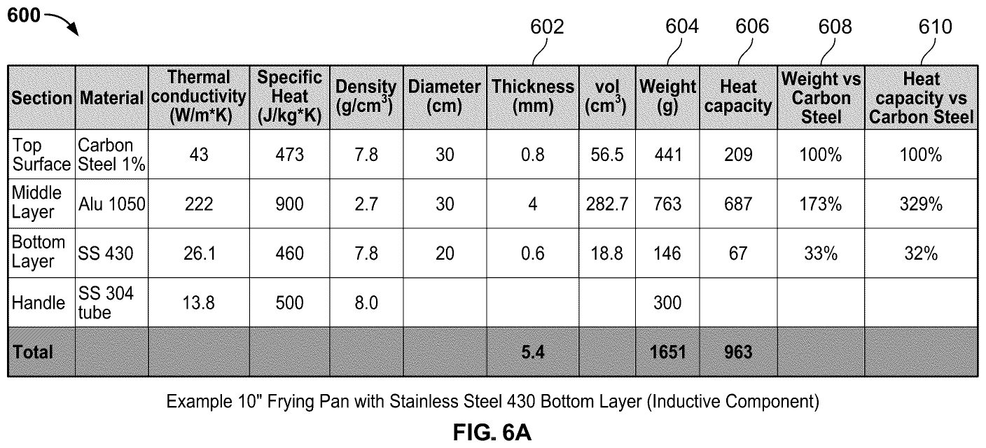

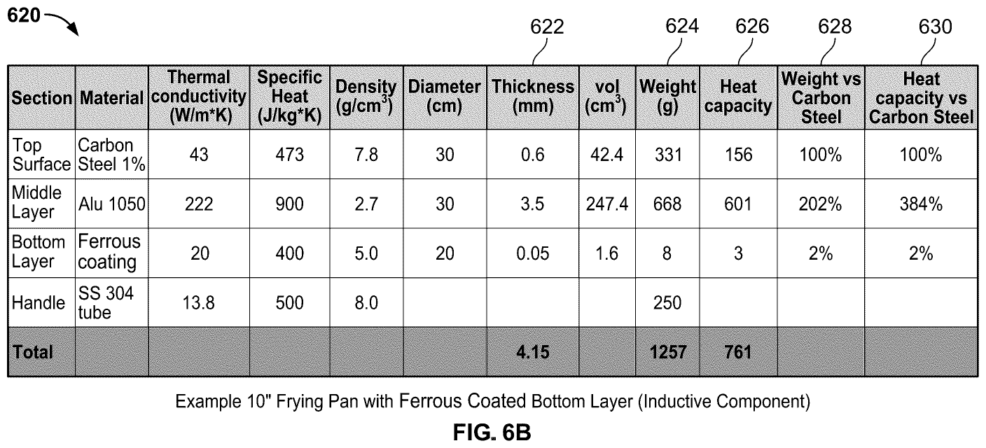

FIG. 6A is a diagram illustrating an embodiment of sustainable non-stick cookware with a stainless steel bottom layer.

FIG. 6B is a diagram illustrating an embodiment of sustainable non-stick cookware with a ferrous coating as the bottom layer.

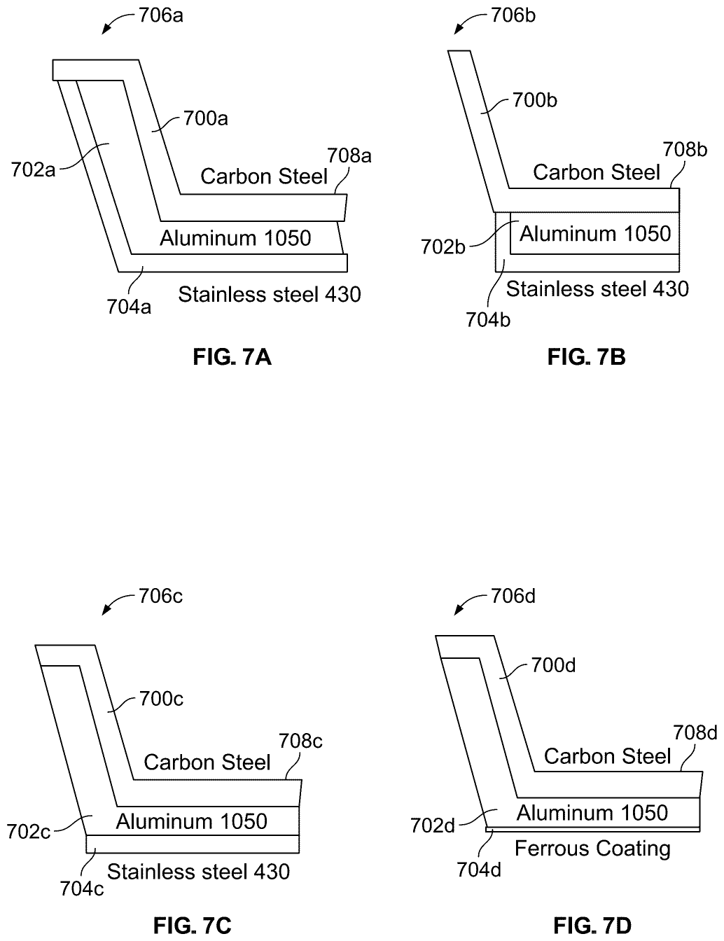

FIG. 7A is a cross-sectional diagram illustrating an embodiment of a side, of a piece of cookware, that includes a top layer, a middle layer, and a bottom layer.

FIG. 7B is a cross-sectional diagram illustrating an embodiment of a side, of a piece of cookware, that includes a top layer.

FIG. 7C is a cross-sectional diagram illustrating an embodiment of a side, of a piece of cookware, that includes a top layer and a middle layer.

FIG. 7D is a cross-sectional diagram illustrating an embodiment of a side, of a piece of cookware with a ferro magnetic coating as the bottom layer, that includes a top layer and a middle layer.

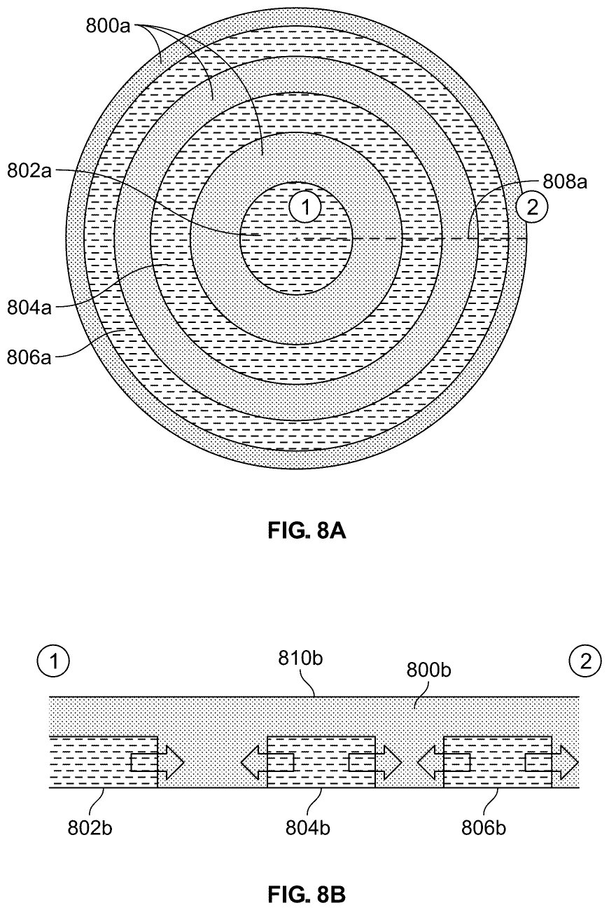

FIG. 8A is a bottom-view diagram illustrating an embodiment of sustainable non-stick cookware with an inlay clad configuration.

FIG. 8B is a cross-sectional diagram illustrating an embodiment of sustainable non-stick cookware with an inlay clad configuration.

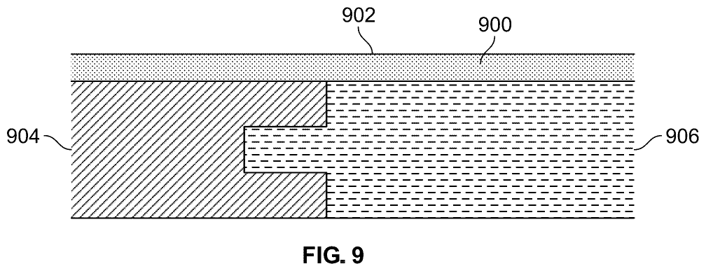

FIG. 9 is a cross-sectional diagram illustrating an embodiment of sustainable non-stick cookware with an edge clad configuration.

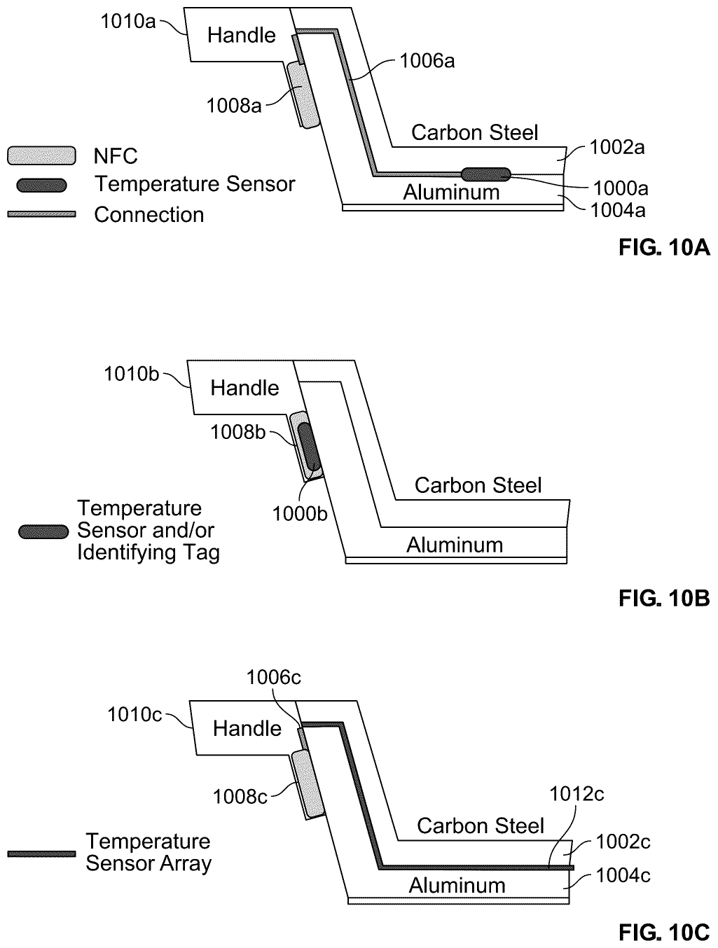

FIG. 10A is a cross-sectional diagram illustrating an embodiment of sustainable non-stick cookware with a temperature sensor embedded beneath a cooking surface.

FIG. 10B is a cross-sectional diagram illustrating an embodiment of sustainable non-stick cookware with a temperature sensor embedded in a handle.

FIG. 10C is a cross-sectional diagram illustrating an embodiment of sustainable non-stick cookware with an embedded temperature sensor array.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various embodiments of sustainable non-stick cookware are described herein. In some embodiments, the sustainable non-stick cookware includes an inductive component (e.g., a ferrous coating on the bottom of the cookware, a bottom layer of stainless steel 430 that is tenths of a mm thick (e.g., 0.6 mm), pieces of an inductive component embedded in a solid piece of material that includes the cooking surface, etc.), a thermal distribution component that distributes heat laterally in the thermal distribution component (e.g., to even out the heat and/or spread it from local hotter regions to local colder regions in the thermal distribution component so that when the heat reaches the (e.g., polymerizable) cooking surface the temperatures are more even), and a cooking surface on which a polymerized layer of seasoning is able to be formed (e.g., so that the cooking surface is non-stick, the non-stick surface is safe and/or non-toxic, and the non-stick surface is able to be reformed at home so that the cookware can last for years).

The following figure illustrates one embodiment of a process to provide such a piece of sustainable non-stick cookware. In some embodiments, the example process is performed by a piece of cookware after manufacturing and before the first use of the cookware by a purchaser.

FIG. 1 is a flowchart illustrating an embodiment of a process to provide sustainable non-stick cookware. In this example, the process of FIG. 1 is performed by a piece of sustainable non-stick cookware. The term “sustainable non-stick cookware” refers to new and/or improved cookware that is manufactured using one or more of the techniques described herein. For brevity and/or convenience, the term “cookware” is sometimes used and “cookware” does not necessarily exclude new and/or improved cookware that is manufactured using one or more of the techniques described herein.

At 100, an inductive component that interacts with an induction coil is provided.

In one example, the inductive component is made of a ferrous material such as stainless steel 430 if the induction coils are operating at a (e.g., regular or standard) frequency of 20-30 kHz. In at least some applications, it is desirable to make the inductive component as thin as possible so that as much heat as possible is generated via induction and/or the inductive component has minimal weight (e.g., to make the cookware easier to handle and work with) and minimal thermal mass (e.g., to make the cookware faster to heat up) is offset by the desire for the inductive component to be sufficiently robust and/or durable. In other words, in at least some applications, it is desirable for the inductive component to be relatively thin (e.g., for good heat generation in response to the induced electromagnetic field) but not so thin that the inductive component cannot withstand wear.

In some embodiments, the inductive component includes one or more of the following: stainless steel, stainless steel 430, a ferrous coating, or aluminum.

In some embodiments, the inductive component comprises a layer having a uniform thickness (e.g., at least throughout the bottom portion of the cookware). In one example, the inductive component has a thickness within the range of 0-18 mm. In some embodiments, the inductive component is a ferrous coating with a thickness on the order of 0.05 mm. Alternatively, in some other embodiments, the inductive component is not a layer, but may comprise some other shape (such as an inlaid plug or ring) and/or has a non-uniform shape or thickness throughout the cookware. An example of this is described in more detail below.

In some embodiments, the material that is used for the inductive component is selected based at least in part on the inductive resonant frequency of the induction coils. For example, if the cookware is designed and/or optimized for high-frequency induction coils (e.g., exceeding a frequency of 20 kHz), then aluminum is an acceptable material for the inductive component. If the thermal distribution component is (also) made of aluminum, then it may not be necessary (e.g., at least in some high-frequency induction applications) to have a separate component for the inductive component (e.g., because the thermal distribution component also acts as the inductive component). To put it another way, in some embodiments, the inductive component and the thermal distribution component are a same (i.e., single) component.

At 102, a thermal distribution component that distributes heat throughout the thermal distribution component, including laterally, is provided.

Conceptually, the thermal distribution component enables a more even temperature at the cooking surface (compared to other types of cookware that are not manufactured using the techniques described herein) by distributing heat from localized hot(ter) areas (e.g., hotter donut-shaped regions that arise from uneven eddy currents in the inductive component) to cold(er) parts of the thermal distribution component before the heat rises to the (e.g., polymerizable and non-stick) cooking surface (e.g., which at least in some embodiments is disposed above or over the thermal distribution component). It is therefore desirable for the thermal distribution component to have a relatively high or otherwise good thermal conductivity.

In some applications, the desire to make the thermal distribution component as thick as possible (e.g., so that more even temperatures are produced at the cooking surface) is offset by the desire to minimize weight and thermal mass. To put it another way, in at least some applications, it is desirable for the thermal distribution component to be relatively thick, but not so thick that the cookware is too heavy or too cumbersome, nor too slow to heat up.

In some embodiments, the thermal distribution component includes one or more of the following: aluminum, aluminum alloy, aluminum 1050, tin, molybdenum alloy, copper, silver, pyrolytic carbon, or graphite.

In some embodiments, the thermal distribution component includes multiple types of materials (e.g., each with different (e.g., thermal) properties and/or different thicknesses or dimensions) to produce an anisotropic heat conduction condition where thermal conductivity in the lateral direction (e.g., parallel with the plane of a flat cooking surface of the cookware) is reduced (or less than that in the vertical direction) and/or thermal conductivity in the vertical direction (e.g., perpendicular to the plane of a flat cooking surface of the cookware) is increased (or greater than that in the lateral direction). To put it another way, a combination of materials with different shapes and/or thermal properties is arranged so that moving heat laterally is “easier” than moving heat vertically.

At 104, a cooking surface on which a polymerized layer of seasoning is able to form is provided, wherein the polymerized layer of seasoning makes the cooking surface non-stick and the polymerized layer of seasoning is able to be reformed a plurality of times on the cooking surface.

In some applications, the desire to make the component and/or layer that includes the cooking surface as thin as possible (e.g., so that it has a relatively low weight) is balanced by the desire for the cooking surface to be sufficiently robust and/or durable. To put it another way, it may be desirable (at least in some applications) for the (component and/or layer that includes) the cooking surface to be relatively thin (e.g., for weight reasons) but not too thin (e.g., for durability reasons).

In some embodiments, a component (e.g., a top layer of a piece of cookware) that includes (or otherwise provides) the cooking surface further includes one or more of the following: carbon steel, carbon steel 1%, cast iron, or enameled cast iron.

In some embodiment, the process of FIG. 1 is performed by one or more of the following: a pan (e.g., a frying pan, grill pan, griddle pan, etc.), a pot, a skillet, a wok, a Dutch oven, etc. To put it another way, in some embodiments, the sustainable non-stick cookware described herein takes on or otherwise includes one or more of the above shapes, forms, or types of cookware.

As used herein, the term “cooking surface” refers to an exposed surface of the cookware on which food and/or liquids are placed for cooking and/or heating. With some types of cookware (e.g., a frying pan), the cooking surface is a flat or planar surface. With some other types of cookware (e.g., a wok), the cooking surface includes a sloped or curved surface, a (side) wall, etc.

A layer of polymerized fat or oil forms on a cooking surface after the fat or oil is sufficiently heated. The heated fat or oil forms a bioplastic that coats the cooking surface with a heat-, corrosion-, and stick-resistant hard coating. This polymerized layer is sometimes referred to as “seasoning” and the term “polymerized layer of seasoning” is used herein (see, e.g., step 104 in FIG. 1).

The cooking surface embodiments and/or techniques described herein are understood to exclude cooking surfaces that have been treated with a synthetic compound such as PTFE or PFAS.

Compared to synthetic compounds such as PTFE or PFAS, there is much less concern about the health impacts of the polymerized layer of seasoning. Also, a polymerized layer of seasoning can be reformed again and again, even in a home setting (e.g., if the polymerized layer of seasoning is scraped off or removed in some other manner, a home chef can reform the polymerized layer of seasoning with readily available ingredients and tools). As such, the cookware embodiments described herein are much more attractive compared to other types of non-stick cookware (e.g., treated with synthetic compounds) because they are safer to cook with and are more sustainable (e.g., because the non-stick layer of seasoning can be reformed and the cookware does not need to be replaced every year or so if the non-stick layer scrapes off).

It is noted that a cooking surface (e.g., recited in step 104 of FIG. 1) includes or is otherwise associated with cookware that is sold pre-seasoned (e.g., where the polymerized layer of seasoning is applied or otherwise formed at the factory and/or industrially by the manufacturer prior to sale) as well as cookware that is sold unseasoned (e.g., where the cookware is sold without any polymerized layer of seasoning already developed or formed, and the buyer must develop that polymerized layer of seasoning at home). For example, both pre-seasoned cookware and unseasoned cookware (manufactured according to the techniques described herein) have a cooking surface on which a polymerized layer of seasoning can and/or does form.

It is also noted that a cooking surface (e.g., recited in step 104 of FIG. 1) does not necessarily exclude bluing. During a bluing process, an oxidizing chemical reaction on an iron surface (e.g., a cooking surface) selectively forms magnetite (Fe₃O₄), the black oxide of iron. The black oxide provides protection against corrosion (e.g., in addition to the protection offered by a polymerized layer of seasoning) if treated with a water-displacing oil to reduce wetting and galvanic action (e.g., where it is often recommended that a (e.g., polymerizable) cooking surface have a thin layer of oil for storage and/or when not in use, so there is often oil present on a polymerized layer of seasoning both during cooking and while stored). To put it another way, in some embodiments, a cooking surface (e.g., recited in step 104 of FIG. 1) includes a cooking surface that has undergone a bluing process to form, create, or otherwise apply magnetite on the cooking surface.

It is noted that although some of the embodiments and/or benefits described herein are in the context of induction cooking, the cookware embodiments and associated benefits described herein are not limited to induction cooking and work with other types of cooktops. That is, the cookware embodiments described can be used with all types of cooking, including cooking over gas, electric coil, etc.

Although there are other types of cookware (e.g., cookware made entirely of carbon steel) that address the health concerns and durability associated with PTFE and PFAS coated cookware, such existing cookware is still deficient and/or underperforms compared to the improved cookware and/or techniques recited herein (one example of which is recited in Figure 1). The following figures illustrate some drawbacks associated with such other types of cookware.

FIG. 2A is a thermal image illustrating a first example of another type of cookware on an induction cooktop. In this example, the exemplary cookware (which is not constructed using the techniques described herein) is a 10-inch, (entirely) carbon steel griddle pan. In the thermal image shown here, the induction cooktop has been turned on for 25 seconds at full power. Table 1 (below) shows various temperatures measured from the heated cookware. Point 200a is located at the center of the pan, point 204a is located at the edge of the flat cooking surface, and point 202a is the midpoint between those two points.

The other two temperatures (shown in the second-from-right column and rightmost column in Table 1) are the hottest and coldest temperatures, respectively, corresponding to a “hot ring” (206a) on the flat cooking surface of the cookware and the side of the cookware (208a) which tends to be the coolest part of a pan or pot. For context, the inner circle (212a) shows the perimeter of the flat cooking surface and the outer circle (214a) shows the rim of the cookware.

TABLE 1
Measured temperatures associated with the exemplary
thermal image shown in FIG. 2A

| Point 200a | Point 202a | Point 204a | Point 206a | Point 208a |
|---|---|---|---|---|
| 89.9° C. | 157° C. | 55° C. | 163° C. | 25.7° C. |

In this example, the induction cooktop is a portable induction cooktop (sometimes referred to as a tabletop induction cooktop) that includes one or more rings or donuts of induction coils. That is, the area beneath the bottom surface of the cookware is not entirely or completely populated with induction coils. As a result, the induced electromagnetic field experienced by the cookware is not uniform, producing the uneven thermal response shown in FIG. 2A (and also in FIG. 2B).

The undesirable temperature difference shown here is not limited to (existing) carbon steel cookware. The following figure shows a similar undesirable temperature difference for (existing) aluminum cookware.

FIG. 2B is a thermal image illustrating a second example of another type of cookware on an induction cooktop. In this example, the exemplary cookware (which is not constructed using the techniques described herein) is a 10-inch, (entirely) aluminum frying pan. In the thermal image shown here, the induction cooktop has been turned on for 25 seconds at full power (where the induction cooktop is the same as that used in FIG. 2A). Table 2 (below) shows various temperatures measured from the heated cookware.

In this example, point 200b is located at the center of the pan, point 204b is located at the edge of the flat cooking surface, point 202b is the midpoint between those two points, point 206b corresponds to the hottest measured temperature, point 208b corresponds to the lowest measured temperature, the inner circle (212b) shows the perimeter of the flat cooking surface, and the outer circle (214b) shows the rim of the cookware.

TABLE 2
Measured temperatures associated with the exemplary
thermal image shown in FIG. 2B.

| Point 200b | Point 202b | Point 204b | Point 206b | Point 208b |
|---|---|---|---|---|
| 93.1° C. | 100° C. | 51.7° C. | 105° C. | 22.3° C. |

The exemplary cookware shown in FIGS. 2A and 2B respond similarly to other types of portable induction cooktops (e.g., multiple rings with significant temperature differences). For brevity, additional thermal images showing the exemplary cookware on other types of portable induction cooktops are not shown herein.

As shown in the examples of FIGS. 2A and 2B, these other types of cookware suffer from significant temperature differences on the induction cooktop, which is of particular concern when cooking solid foods (e.g., as opposed to heating water or other liquids). For example, suppose there is a large piece of meat (e.g., 210a in FIG. 2A and 210b in FIG. 2B) that is placed on the flat cooking surface. The part(s) of the meat (210a/210b) above a hot spot (e.g., 206a/206b) will be cooked at temperatures of 163° C. or 105° C. whereas the part(s) of the meat above the center of the pan (e.g., 200a/200b) will be cooked at temperatures of 89.9° C. or 93.1° C. This corresponds to a peak-and-center delta of 73.1° C. and 11.9° C. for FIGS. 2A and 2B, respectively.

Optimal cooking performance occurs when the temperature is constant or otherwise even across the cooking surface so that (as an example) the chef can achieve a consistent doneness throughout the inside of the piece of meat. For example, a lower peak-and-center delta (i.e., lower than the peak-and-center deltas of 73.1° C. and 11.9° C. associated with FIGS. 2A and 2B the) would be desirable since it would cook food more evenly (e.g., it would be undesirable for some parts of the meat (210a/210b) to be overcooked and for other parts of the meat to be undercooked). The techniques and/or systems described herein provide cookware with improved performance on induction cooktops, in addition to minimal health concerns and sustainability (e.g., due to better durability).

Although one solution is to manually control the induction cooktop and/or move the cookware around on the induction cooktop to induce more even temperatures on the cooking surface, this is suboptimal. For example, this requires some user experience and/or user judgement that a novice user will probably lack. In contrast, the improved cookware described herein would simply achieve more even temperatures without user manipulation, experience, and/or judgement so that even a novice cook could achieve more even temperatures across the cooking surface.

Similarly, even though more sophisticated and/or more expensive induction cooktops through a variety of techniques may be able to produce more even temperatures with existing cookware (e.g., such as that shown in FIGS. 2A and 2B), more sophisticated and/or more expensive induction cooktops are not always available. For example, a home chef who is a renter may be stuck with a basic induction cooktop that does not work well with existing cookware. Even if a chef is a homeowner or a professional chef, it may be cost prohibitive and/or infeasible to replace existing ranges or cooktops that do not work well with existing cookware. In contrast, with the improved cookware embodiments described herein, more even temperatures can be produced without the need for new and/or more expensive induction cooktops. Cookware that achieves more even temperatures with any type of induction cooktop (including less expensive and/or less sophisticated ones) would be desirable.

The following figures illustrate an example of how one embodiment of sustainable non-stick cookware (manufactured according to the techniques described herein) is able to achieve more even temperatures without requiring user intervention and/or even with less expensive and/or less sophisticated induction cooktops.

FIG. 3A is a cross-sectional diagram illustrating an embodiment of sustainable non-stick cookware, with an overlay clad configuration, before induction coils are turned on. In this example, the cookware includes (from top to bottom): a (e.g., polymerizable) cooking surface (302a), a thermal distribution component (304a), and an inductive component (306a). In the state shown here, a polymerized layer of seasoning (300a) has already been formed on the cooking surface (302a). In some embodiments, the cookware is sold pre-seasoned, and the cookware is sold with the polymerized layer of seasoning (300a) already on the cooking surface (e.g., developed or otherwise formed in the factory). In other embodiments, the cookware is sold unseasoned without the polymerized layer of seasoning (300a) on the cooking surface, and the polymerized layer of seasoning (300a) developed or formed after purchase.

For simplicity and ease of explanation, it is assumed that the sustainable non-stick cookware is centered on the inductive cooktop so that line 312a is both the center of the sustainable non-stick cookware as well as the center of the inductive cooktop. As such, the induction coils at right (308a) comprise an inner ring of induction coils and the induction coils at left (310a) comprise an outer ring of induction coils. It is noted that the cookware and inductive cooktop shown here are merely exemplary and are not intended to be limiting. For example, other types of inductive cooktops may have a different number and/or arrangement of induction coils than the example shown here. Similarly, other embodiments of sustainable non-stick cookware may have a different number and/or arrangement of components and/or materials than the example shown here.

The following table illustrates example materials and thickness ranges for the sustainable non-stick cookware shown in FIG. 3A.

TABLE 3
Example materials and thickness ranges associated with FIG. 3A.

| | Inductive | Thermal | Cooking |
|---|---|---|---|
| | component | distribution | surface |
| | (306a) | component (304a) | (302a) |
| Example Material | Stainless steel | Aluminum | Carbon steel |
| Example Thickness | 0-1.8 mm | 2-8 mm | 0.4-3.0 mm |
| Range | | | |

The following figure shows the example system at a second and later point in time.

FIG. 3B is a cross-sectional diagram illustrating an embodiment of sustainable non-stick cookware, with an overlay clad configuration, after the induction coils are turned on. In the example shown here, the induction coils (308b and 310b) have been turned on and the inductive component (306b) responds to the induced electromagnetic field (not shown) so that hot regions (314b and 316b) form within the inductive component (306b) over the induction coils (308b and 310b).

The following figure shows the example system at a third and later point in time.

FIG. 3C is a cross-sectional diagram illustrating an embodiment of sustainable non-stick cookware, with an overlay clad configuration, with the thermal distribution component distributing heat laterally in addition to vertically. In the example shown here, the thermal distribution component (304c) is made of a material that is a good thermal conductor, so that heat is distributed not only vertically but also laterally. As a result, when the heat from the hot regions (314c and 316c) in the inductive component (306c) enters the thermal distribution component (304c), the resulting hot regions (314c and 316c) have funnel-shaped hot regions (318c and 320c). In the state shown here, the hot regions (318c and 320c) have overlapped. As will be described in more detail below, this helps to produce more even temperatures at the cooking surface.

The following figure shows the example system at a fourth and later point in time.

FIG. 3D is a cross-sectional diagram illustrating an embodiment of sustainable non-stick cookware, with an overlay clad configuration, with the (e.g., polymerizable) cooking surface heating up. In the example shown here, the heat from the overlapping hot regions (318d and 320d) in the thermal distribution component (304d) has entered the cooking surface (302d), causing hot regions (322d and 324d) to form within the cooking surface (302d). As a result of the thermal distribution component (304d) moving heat laterally in addition to vertically, hot regions 318d and 320d overlap and hot regions 322d and 324d overlap, producing more even temperatures at the cooking surface, which is desirable.

The following figure illustrates a similar cross section for other types of cookware (e.g., not constructed according to the techniques described herein).

FIG. 4 is a cross-sectional diagram illustrating an example of another type of cookware. In this example, the cookware is constructed entirely of a single material (400) that acts as both the inductive component and the (e.g., polymerizable) cooking surface (and is therefore not constructed according to the techniques described herein). In this example, the inductive component (400), is made (entirely) of carbon steel, on which a polymerized layer of seasoning (402) is shown (because the inductive component (400) also includes or acts as the cooking surface).

For context, line 404 is the center of the cookware and inductive cooktop. The induction coils at right (406) comprise an inner ring of induction coils and the induction coils at left (408) comprise an outer ring of induction coils.

In this example, the electromagnetic field (not shown) induced by the induction coils (406 and 408) causes hot regions (410 and 412) to form within the inductive component (400). Since the inductive component (400) is made of a material (in this example, carbon steel) that is a relatively poor conductor of heat, the hot regions (410 and 412) rise substantially vertically from the induction coils (406 and 408) and are spread laterally throughout the inductive component (400) only minimally. As a result, the hot regions (410 and 412) do not overlap which causes rings or donuts with substantial temperature difference at the polymerized layer of seasoning (402). See, for example, the thermal images shown in FIGS. 2A and 2B.

In contrast, the thermal distribution component embodiments described herein move heat laterally (see, e.g., FIGS. 3A-3D) so that the heat or temperature is more evenly distributed (e.g., due to overlapping hot regions) when the heat reaches an interface between a thermal distribution component and a cooking surface.

In some embodiments, the thermal distribution component is made of a material that has a thermal diffusivity that exceeds some minimum or threshold value. The following figure shows an example of this.

FIG. 5 is a diagram illustrating an embodiment of thermal values associated with various materials. As described above, for a thermal distribution component to sufficiently move heat laterally and even out temperatures at the cooking surface (e.g., so that localized hot spots do not merely propagate upwards, resulting in uneven and localized hot spots at the cooking surface), the thermal distribution component should be made of a material with relatively good heat transfer properties.

In this example, table 500 shows the thermal conductivity for example materials that are commonly used in cookware fabrication: copper, aluminum, cast iron, carbon steel, and stainless steel. As shown in table 500, the thermal conductivity is 401 W/(m·K) for copper, 237 W/(m·K) for aluminum, 80 W/(m·K) for cast iron, 51 W/(m·K) for carbon steel, and 16 W/(m·K) for stainless steel.

Table 502 shows the specific heat and density of the example materials: 390 J/(kg·K) and 8900 kg/m³ (respectively) for copper, 910 J/(kg·K) and 2600 kg/m³ (respectively) for aluminum, 460 J/(kg·K) and 7900 kg/m³ (respectively) for cast iron, 500 J/(kg·K) and 7500-8000 kg/m³ (respectively) for carbon steel, and 500 J/(kg·K) and 7500-8000 kg/m³ (respectively) for stainless steel,

Thermal diffusivity (shown in table 504) measures or otherwise represents the rate of transfer of heat of a material (e.g., from a hot(ter) end to a cold(er) end) and is therefore a good metric or property to select the material for the thermal distribution component. The thermal diffusivity (shown in table 504) is the thermal conductivity (shown in table 500) divided by the density and the specific heat capacity (both of which are shown in table 502) at a constant pressure. The example materials in table 504 are sorted in descending order of thermal diffusivity and are therefore sorted from top-to-bottom in order of better-to-worse material for a thermal distribution component.

As is shown in the thermal diffusivity table (504), aluminum has one of the best thermal properties (e.g., thermal diffusivity) for cookware, especially compared against common cookware materials such as stainless steel, carbon steel, and cast iron. The thermal diffusivity of aluminum is at least one order of magnitude larger (i.e., better) than that of cast iron, carbon steel, and stainless steel. Copper has better thermal properties but is significantly more expensive than aluminum. For cost reasons, aluminum may be preferred over copper in at least some applications.

In some embodiments, a thermal distribution component (e.g., referred to in step 102 of FIG. 1) has a thermal diffusivity that exceeds 25×10⁻⁶ m²/s. For example, iron has at least a thermal diffusivity of 25×10⁻⁶ m²/s, which is double that of carbon steel, and is therefore an acceptable material to use in the thermal distribution component (at least in some applications).

It may be helpful to illustrate some embodiments having a specific configuration (e.g., with specific dimensions, materials, weights, etc.). The following figure illustrates two such examples that achieve different weight and heat capacities.

FIG. 6A is a diagram illustrating an embodiment of sustainable non-stick cookware with a stainless steel bottom layer (i.e., inductive component). In this example, the table (600) shows specific materials and dimensions for an example 10-inch frying pan with a stainless steel 430 bottom layer (i.e., inductive component). The table (600) shows various measurements or values for the various layers or components (including a top surface (e.g., which includes a cooking surface), a middle layer (e.g., thermal distribution component), bottom layer (e.g., inductive component), and a handle). These measurements or values include: thickness (602), weight (604), heat capacity (606), weight versus carbon steel (608), and heat capacity versus carbon steel (610).

FIG. 6B is a diagram illustrating an embodiment of sustainable non-stick cookware with a ferrous coating as the bottom layer (i.e., inductive component). In this example, the table (620) shows the same for an example 10-inch frying pan with a ferrous coated bottom layer (i.e., inductive component), including thickness (622), weight (624), heat capacity (626), weight versus carbon steel (628), and heat capacity versus carbon steel (630).

For example, the cookware embodiment described in the table (620) may be desirable in applications where a lighter and/or thinner piece of cookware is desired. In that example configuration, each of the layers is slightly thinner and lighter compared to the cookware embodiment described in the table (600) and the ferrous coated bottom layer is only 8 g (see table 602) versus the 146 g bottom layer offered by the stainless steel 430 (see table 600).

A drawback of ferrous coating is that it is less durable than a thicker inductive layer would be. In applications where a more durable piece of cookware is desired, the cookware embodiment described in the table (600) may be more attractive.

As is shown in the table (600), having a middle layer (i.e., thermal distribution component) that is made of aluminum 1050 and is 4 mm thick (see column 602) is 173% heavier than a corresponding middle layer made of carbon steel (see column 608), but it also has 329% more of the heat capacity of a corresponding middle layer made of carbon steel (see column 610). To put it another way, although a 4 mm middle layer of aluminum 1050 is heavier than one made of carbon steel, the improvement in heat capacity is significantly greater than the increase in weight (i.e., 329%>>173%) which implies that the tradeoff is worthwhile.

In the table (620), the middle layer (i.e., thermal distribution component) is made of aluminum 1050 and is 3.5 mm thick (see column 622) which produces a weight that is 202% that of carbon steel (see column 628), which is significantly less than the 384% of heat capacity versus carbon steel (see column 630). The cookware embodiments described in FIG. 6 are merely exemplary and are not intended to be limiting.

Returning briefly to the cross sectional views of the overlay clad embodiments shown in FIGS. 3A-3D, the sides (sometimes referred to as side walls) of the exemplary cookware may be implemented in a variety of ways. The following figures illustrate some examples.

FIG. 7A is a cross-sectional diagram illustrating an embodiment of a side, of a piece of cookware, that includes a top layer, a middle layer, and a bottom layer. In the example shown, the top layer (700a) is made of carbon steel and is associated with or otherwise includes a (e.g., polymerizable) cooking surface. The middle layer (702a) is made of aluminum 1050 and includes or is otherwise associated with a thermal distribution component. The bottom layer (704a) is made of stainless steel 430 and includes or is otherwise associated with the inductive component. As shown here, the side (706a) extends away from and/or is not parallel to the plane of the cooking surface (708a). In this example, the side (706a) includes the top layer (700a), the middle layer (702a), and the bottom layer (704a).

As is shown in this example, in some embodiments, a piece of sustainable non-stick cookware (further) includes a side (e.g., 706a) that includes the inductive component (e.g., 704a), the thermal distribution component (e.g., 702a), and a component (e.g., 700a) that includes the cooking surface (e.g., 708a), wherein the component (e.g., 700a) that includes the cooking surface further includes an interior-facing surface of the side and the inductive component (e.g., 704a) includes an exterior-facing surface of the side.

FIG. 7B is a cross-sectional diagram illustrating an embodiment of a side, of a piece of cookware, that includes a top layer. In this example, the side (706b), which includes (only) the top layer (700b) extends away from and/or is not parallel to the plane of the cooking surface (708b). Neither the middle layer (702b) nor the bottom layer (704b) are included in the side (706b).

As is shown in this example, in some embodiments, a piece of sustainable non-stick cookware includes a side (e.g., 706b) that includes a component (e.g., 700b), wherein the component includes: (1) the cooking surface (e.g., 708b), (2) an interior-facing surface of the side, and (3) an exterior-facing surface of the side.

FIG. 7C is a cross-sectional diagram illustrating an embodiment of a side, of a piece of cookware, that includes a top layer and a middle layer. In this example, the side (706c), extends away from and/or is not parallel to the plane of the (e.g., polymerizable) cooking surface (708c) and includes (only) the top layer (700c) and the middle layer (702c). The bottom layer (704c) is not part of the side (706c).

As is shown in this example, in some embodiments, a piece of sustainable non-stick cookware includes a side (e.g., 706c) that includes the thermal distribution component (e.g., 702c) and a component (e.g., 700c) that includes the cooking surface (e.g., 708c), wherein the component (e.g., 700c) that includes the cooking surface further includes an interior-facing surface of the side and the thermal distribution component (e.g., 702c) includes an exterior-facing surface of the side.

FIG. 7D is a cross-sectional diagram illustrating an embodiment of a side (e.g., 706d), of a piece of cookware with a ferro magnetic coating as the bottom layer, that includes a top layer and a middle layer. In this example, the top layer (700d) and middle layer (702d) are made of carbon steel and aluminum 1050, respectively, as in the previous figures. However, in this example, the bottom layer (704d) is made of a ferro magnetic coating.

The example of FIG. 7D is similar to the example of FIG. 7C, in that the sides (706c/706d), which extend away from the plane of the cooking surface (708c/708d), includes (only) the top layer (700c/700d) and the middle layer (702c/702d), but not the bottom layer (704c/704d).

As is shown in this example, in some embodiments, a piece of sustainable non-stick cookware includes a side (e.g., 706d) that includes the thermal distribution component (e.g., 702d), and a component (e.g., 700d) that includes the cooking surface (e.g., 708d), wherein the component (e.g., 700d) comprises an interior-facing surface of the side, the thermal distribution component (e.g., 702d) comprises an exterior-facing surface of the side, and the inductive component includes a ferrous coating (e.g., 704d).

As described above, in some high-frequency induction applications, aluminum or other materials may be used as both the thermal distribution component and the inductive component. The following figures illustrate an example of this.

FIG. 8A is a bottom-view diagram illustrating an embodiment of sustainable non-stick cookware with an inlay clad configuration. In this diagram, the exemplary sustainable non-stick cookware shown has an inlay clad configuration so that three concentric rings of aluminum (802a, 804a, and 806a), which act as both the thermal distribution component and the inductive component, are embedded in a (single) piece of carbon steel (800a) that includes or otherwise provides the cooking surface.

The following figure shows the example cross section corresponding to line 808a.

FIG. 8B is a cross-sectional diagram illustrating an embodiment of sustainable non-stick cookware with an inlay clad configuration. In the view shown here, the top surface (810b) is the cooking surface which is provided by or otherwise included in the (single piece of) carbon steel (800b).

The inlaid aluminum sections (802b, 804b, and 806b) are positioned on the bottom surface of the cookware so that they are at or near the induction coils (not shown). Placing the inlaid aluminum sections (which act as the inductive component) next to the induction coils is desirable because the power consumed by the inductive cooktop is more efficiently translated into heat for cooking.

The exemplary cookware shown here is (e.g., specifically) designed for a high-frequency induction cooktop where aluminum (e.g., 802b, 804b, and 806b) has good heat generation and/or inductive response to the frequency of the induction coils (now shown). In other applications (e.g., with lower frequencies where aluminum is not a good inductive component), some other type of material may be used for the inductive component and/or a different number and/or arrangement of components may be used in an inlay clad configuration.

In some embodiments, the exemplary cookware shown here is (e.g., specifically) optimized for a specific brand or model of induction cooktop (but may still be usable with other induction cooktop brands or models). For example, a manufacturer of induction cooktops may also make and sell sustainable non-stick cookware that is designed and/or optimized for that manufacturer's specific placement and/or arrangement of induction coils. For example, the inlaid inductive components (e.g., 802b, 804b, and 806b) may be placed directly above the induction coils and/or the cross-sectional width of each inlaid inductive component is tuned for the width of a given ring, donut, or group of induction coils.

As shown here, in some embodiments, the inductive component and the thermal distribution component are a same component (e.g., 802a/802b, 804a/804b, and 806a/806b).

As shown here, in some embodiments, the inductive component and the thermal distribution component are a same component (e.g., 802a/802b, 804a/804b, and 806a/806b) and said same component includes at least one inlaid ring (e.g., 804a and 806a) that includes aluminum.

In some embodiments, the various components in a piece of sustainable non-stick cookware are configured or otherwise arranged using an edge clad. The following figure shows an example of this.

FIG. 9 is a cross-sectional diagram illustrating an embodiment of sustainable non-stick cookware with an edge clad configuration. In this example, a top layer (900) is made of carbon steel which includes or otherwise provides the (e.g., polymerizable) cooking surface (902). Beneath the top layer (900) are sections or components of stainless steel (904) and aluminum (906). As shown in this configuration, both the stainless steel (904) and aluminum (906) are exposed on a bottom surface (e.g., facing and/or next to the induction coils of the induction cooktop) with the aluminum (906) penetrating into the stainless steel (904) with this exemplary edge cladding.

In some embodiments, a piece of sustainable non-stick cookware includes an embedded component and/or communication module that is read by or otherwise communicates with an (e.g., induction) cooktop and used by the cooktop in a variety of ways. For example, such an embedded component may include an identifying tag or sensor (e.g., RFID, NFC RFID, etc.), such as one or more temperature sensors. The following figures show some examples of this.

FIG. 10A is a cross-sectional diagram illustrating an embodiment of sustainable non-stick cookware with a temperature sensor embedded beneath a cooking surface. In this example, a temperature sensor (1000a) is embedded between a top layer (1002a) of carbon steel (e.g., which includes or otherwise provides a cooking surface) and a middle layer (1004a) of aluminum (e.g., the thermal distribution component). The temperature sensor (1000a) is connected to a near-field communication (NFC) module (1008a) in the handle (1010a) via a connection (1006a) that is (also) layered between the top layer (1002a) and middle layer (1004a). The NFC module (1008a) provides power to the temperature sensor (1000a) and allows the temperature values that are measured by the temperature sensor (1000a) to be obtained or otherwise received by an induction cooktop (not shown) or other type of cooktop with NFC or other communication capabilities. In one example, the NFC module (1008a) is able to provide on the order of 1 W of power to the temperature sensor (1000a) and exchange on the order of 106 kbps of data (e.g., measured temperature values), per NFC Forum's latest Wireless Charging Specification (WLC) standard, between the temperature sensor (1000a) and a stove, range, or other cooktop.

In one example application, the (e.g., induction) cooktop uses the received temperature(s) to adjust the power setting of the cooktop. For example, if the cooktop is trying to maintain some desired temperature, then the cooktop may adjust the power setting in response to the measured temperature.

Embedding a sensor (e.g., 1000a) or other component between layers as shown here may be desirable because it helps to protect the component from damage, maintains the non-stick coating on the cooking surface, and/or the middle layer (i.e., the thermal distribution component) is a good thermal conductor and is therefore a good place to position a temperature sensor.

FIG. 10B is a cross-sectional diagram illustrating an embodiment of sustainable non-stick cookware with a temperature sensor embedded in a handle. In this example, the temperature sensor (1000b) is embedded in or otherwise part of the NFC module (1008b) in the handle (1010b). For example, this eliminates the need for a connection between the temperature sensor (1000b) and the NFC module (1008b), which may help with durability and reduces the cost and number of parts and is preferable in some applications.

Or, if the temperature sensor (1000b) were instead replaced with some identifying tag or module that provides identifying information, putting an identifying tag in the handle and/or in the NFC module may be a good location (e.g., because the handle is cooler and in general it is better to keep an identifying tag away from heat). In one example application, the (e.g., induction) cooktop uses received identifying information to adjust some interface or setting of the cooktop. For example, the identifying information may permit the cooktop to determine what material is used for the inductive component (e.g., whether it is aluminum, stainless steel, or some other material) and therefore what inductive resonant frequency or other cooktop setting or configuration is optimal or best suited for that material (e.g., to heat up the cookware as quickly and/or evenly as possible without wasting power, given the thermal properties and/or inductive properties of the material(s)).

In another example, received identifying information may permit the (e.g., induction) cooktop to know the diameter of the cookware and adjust the number of active or powered-up inductions coils. For example, this may conserve power by not unnecessarily powering up larger diameter inductions coils that are not needed for a smaller diameter pot or pan.

In another example, received identifying information may permit the (e.g., induction) cooktop to expose (or conversely hide) features, permissions, or other services of the cooktop internal settings that a specific user or specific piece of cookware is associated with or entitled to. For example, there may be paid-for services or features that are exposed by a user interface of the induction cooktop when supported cookware is identified (e.g., uniquely using a unique identifier). Or, a user may have saved a preferred layout or arrangement of the user interface of the induction cooktop, and that saved layout or arrangement is retrieved and presented when an associated piece of cookware is identified.

In some embodiments, the received identifying information is unique (e.g., a serial number that uniquely identifies the cookware). In some other embodiments, the received identifying information is not unique (e.g., a model number, which is not unique to a particular piece of cookware). In some embodiments, the received identifying information (e.g., the embedded ID number) is used to look up additional information about the cookware (e.g., stored in a lookup table or other storage or memory) which may be too large to store (e.g., directly) in an identifying tag. In some embodiments, looked-up and/or stored information includes the diameter of the cookware, materials for the various components or layers, a model number, a manufacturing batch number, a unique serial number, etc.

FIG. 10C is a cross-sectional diagram illustrating an embodiment of sustainable non-stick cookware with an embedded temperature sensor array. In this example, a temperature sensor array (1012c) which reports multiple temperatures at different locations is sandwiched between a top layer (1002c) and a middle layer (1004c), including in the flat, bottom portion of the cookware and the side. The temperature sensor array (1012c) is connected to the NFC module (1008c) via a connection (1006c) between the handle (1010c) and the middle layer (1004c). In some embodiments, the temperature sensor array (1012c) includes a wide-area temperature sensor array, a thin-film temperature sensor array, and/or a printed temperature sensor array.

In some embodiments, induction coils are independently controllable, and the received array of measured temperatures enables more accurate and specific adjustment of the induction coils. For example, even with sustainable non-stick cookware, there may be localized differences in temperature, for example, due to a piece of food being placed on the cooking surface and absorbing heat where the food makes contact but not absorbing heat where there is no contact. A (e.g., 2D) array of measured temperatures would be able to detect such a localized temperature drop and independently adjust induction coils (or other heat source) accordingly.

As described above, in some embodiments, sustainable non-stick cookware (further) includes one or more temperature sensors that exchange one or more measured temperatures with a cooktop via near-field communication (NFC), wherein the one or more measured temperatures are used to configure the cooktop.

As described above, in some embodiments, sustainable non-stick cookware (further) includes one or more temperature sensors that exchange one or more measured temperatures with a cooktop via near-field communication (NFC), wherein: the one or more measured temperatures are used to configure the cooktop; and the one or more temperature sensors includes one or more of the following: a temperature sensor array, a wide-area temperature sensor array, a thin-film temperature sensor array, or a printed temperature sensor array.

As described above, in some embodiments, sustainable non-stick cookware (further) includes an identifying module that exchanges identifying information associated with the sustainable non-stick cookware with a cooktop via near-field communication (NFC), wherein the identifying information is used to configure the cooktop.

As described above, in some embodiments, sustainable non-stick cookware (further) includes an identifying module that exchanges identifying information associated with the sustainable non-stick cookware with a cooktop via near-field communication (NFC), wherein: the identifying information is used to obtain stored information; and the stored information is used to configure the cooktop.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A sustainable non-stick cookware system, comprising:
an inductive component that interacts with an induction coil;
a thermal distribution component that distributes heat throughout the thermal distribution component, including laterally; and
a cooking surface on which a polymerized layer of seasoning is able to be formed, wherein:
the polymerized layer of seasoning makes the cooking surface non-stick; and
the polymerized layer of seasoning is able to be reformed a plurality of times on the cooking surface.

2. The sustainable non-stick cookware system recited in claim 1, wherein the inductive component includes one or more of the following: stainless steel, stainless steel 430, a ferrous coating, or aluminum.

3. The sustainable non-stick cookware system recited in claim 1, wherein the thermal distribution component includes one or more of the following: aluminum, aluminum alloy, aluminum 1050, tin, molybdenum alloy, copper, silver, pyrolytic carbon, or graphite.

4. The sustainable non-stick cookware system recited in claim 1, wherein a component that includes the cooking surface further includes one or more of the following: carbon steel, carbon steel 1%, cast iron, or enameled cast iron.

5. The sustainable non-stick cookware system recited in claim 1, wherein the sustainable non-stick cookware system includes one or more of the following types of cookware: a pan, a frying pan, a grill pan, a griddle pan, a pot, a skillet, a wok, or a Dutch oven.

6. The sustainable non-stick cookware system recited in claim 1, wherein the thermal distribution component has a thermal diffusivity that exceeds 25×10⁻⁶ m²/s.

7. The sustainable non-stick cookware system recited in claim 1, further including a side that includes the inductive component, the thermal distribution component, and a component that includes the cooking surface, wherein:
the component that includes the cooking surface further includes an interior-facing surface of the side; and
the inductive component includes an exterior-facing surface of the side.

8. The sustainable non-stick cookware system recited in claim 1, further including a side that includes a component, wherein the component includes: the cooking surface, an interior-facing surface of the side, and an exterior-facing surface of the side.

9. The sustainable non-stick cookware system recited in claim 1, further including a side that includes the thermal distribution component and a component that includes the cooking surface, wherein:
the component that includes the cooking surface further includes an interior-facing surface of the side; and
the thermal distribution component includes an exterior-facing surface of the side.

10. The sustainable non-stick cookware system recited in claim 1, wherein the inductive component and the thermal distribution component are a same component.

11. The sustainable non-stick cookware system recited in claim 1, wherein:
the inductive component and the thermal distribution component are a same component; and
said same component includes at least one inlaid ring that includes aluminum.

12. The sustainable non-stick cookware system recited in claim 1, further including: one or more temperature sensors that exchange one or more measured temperatures with a cooktop via near-field communication (NFC), wherein the one or more measured temperatures are used to configure the cooktop.

13. The sustainable non-stick cookware system recited in claim 1, further including: one or more temperature sensors that exchange one or more measured temperatures with a cooktop via near-field communication (NFC), wherein:
the one or more measured temperatures are used to configure the cooktop; and
the one or more temperature sensors includes one or more of the following: a temperature sensor array, a wide-area temperature sensor array, a thin-film temperature sensor array, or a printed temperature sensor array.

14. The sustainable non-stick cookware system recited in claim 1, further including: an identifying module that exchanges identifying information associated with the sustainable non-stick cookware system with a cooktop via near-field communication (NFC), wherein the identifying information is used to configure the cooktop.

15. The sustainable non-stick cookware system recited in claim 1, further including: an identifying module that exchanges identifying information associated with the sustainable non-stick cookware system with a cooktop via near-field communication (NFC), wherein:
the identifying information is used to obtain stored information; and
the stored information is used to configure the cooktop.

16. A method, including:
providing an inductive component that interacts with an induction coil;
providing a thermal distribution component that distributes heat throughout the thermal distribution component, including laterally; and
providing a cooking surface on which a polymerized layer of seasoning is able to be formed, wherein:
the polymerized layer of seasoning makes the cooking surface non-stick; and
the polymerized layer of seasoning is able to be reformed a plurality of times on the cooking surface.

17. The method recited in claim 16, wherein the thermal distribution component has a thermal diffusivity that exceeds 25×10⁻⁶ m²/s.

18. The method recited in claim 16, wherein:
the inductive component and the thermal distribution component are a same component; and
said same component includes at least one inlaid ring that includes aluminum.

19. The method recited in claim 16, wherein:
the inductive component, the thermal distribution component, and the cooking surface are included in a sustainable non-stick cookware system; and
the sustainable non-stick cookware system further includes: one or more temperature sensors that exchange one or more measured temperatures with a cooktop via near-field communication (NFC), wherein the one or more measured temperatures are used to configure the cooktop.

20. The method recited in claim 16, wherein:
the inductive component, the thermal distribution component, and the cooking surface are included in a sustainable non-stick cookware system; and
the sustainable non-stick cookware system further includes: an identifying module that exchanges identifying information associated with the sustainable non-stick cookware system with a cooktop via near-field communication (NFC), wherein the identifying information is used to configure the cooktop.
